(19) United States
(12) Patent Application Publication
(10) Pub. No.: US 2026/0189271 A1
(43) Pub. Date: Jul. 2, 2026

(54) APPARATUS AND METHOD FOR NEAR-FIELD CHANNEL PHASE LINEARIZATION IN EXTREMELY LARGE MIMO SYSTEM

(71) Applicant: ELECTRONICS AND TELECOMMUNICATIONS RESEARCH INSTITUTE, Daejeon (KR)

(72) Inventors: Hyun Duk KANG, Daejeon (KR); Ho Kyung SON, Daejeon (KR); Jung Hwan KIM, Daejeon (KR); Woong Hee LEE, Daejeon (KR)

(21) Appl. No.: 19/431,169

(22) Filed: Dec. 23, 2025

(30) Foreign Application Priority Data
Dec. 26, 2024 (KR) 10-2024-0197711

(51) Int. Cl. H04B 7/0413

(52) U.S. Cl. CPC H04B 7/0413

(57) ABSTRACT

The present invention relates to an apparatus for near-field channel phase linearization in an extremely large-scale multiple-input multiple-output (XL-MIMO) system including an antenna array module, which includes a plurality of isotropic antennas, receives a user's signal in a near-field environment, and independently collects amplitude and phase data of a signal for each antenna by an array composed of the plurality of isotropic antennas.

### CROSS-REFERENCE TO RELATED APPLICATION

This application claims priority to and the benefit of Korean Patent Application No. 10-2024-0197711, filed on Dec. 26, 2024, the disclosure of which is incorporated herein by reference in its entirety.

### BACKGROUND

### 1. Field of the Invention

The present invention relates to an apparatus and method for near-field channel phase linearization in an extremely large-scale multiple-input multiple-output (XL-MIMO) system to improve user location positioning accuracy in a near-field line-of-sight (LoS) channel environment of a sixth-generation (6G) wireless communication system.

### 2. Discussion of Related Art

In 6G wireless communication systems, extremely large-scale multiple-input multiple-output (XL-MIMO) systems, which utilize more antennas than existing technologies to significantly improve spatial freedom and frequency efficiency, are emerging as key technologies.

However, as the number of antennas increases, the Rayleigh distance increases, making it essential to consider the near-field environment in technologies that were previously developed based on assumptions of a far-field.

Here, the Rayleigh distance is the boundary beyond which an electromagnetic wave transitions from a spherical wave to a plane wave, and the near-field and far-field are distinguished based on the Rayleigh distance.

For reference, the far-field and near-field are distinguished based on the propagation characteristics and distance of electromagnetic waves.

In the far-field, electromagnetic waves are assumed to propagate as plane waves, the transmission/reception distance (i.e., the distance between the antenna and the target) is greater than the Rayleigh distance, and the angles of departure and arrival of propagation paths are assumed to be constant for all elements of the antenna array. The far-field assumptions are used in most existing wireless communication systems (e.g., 4G and 5G).

In the near field, electromagnetic waves are assumed to propagate as spherical waves and the transmission/reception distance is less than the Rayleigh distance. Since the angles of departure and arrival of propagation paths and propagation distances vary for each antenna array element, more precise phase and amplitude adjustments are required. This is an essential consideration in next-generation communication systems such as 6G and XL-MIMO systems.

There is a difference in that electromagnetic waves emitted from the antenna array are assumed to propagate as spherical waves in the near-field, unlike in the far-field where the electromagnetic waves are assumed to propagate as plane waves.

Therefore, in the far-field, the angles of departure and arrival of propagation paths are assumed to be constant across the antenna array, but in the near-field, due to the nature of the spherical waves, changes in the angle and distance between the antenna array elements should be considered. Accordingly, precise adjustments of phase and amplitude are required to accurately reflect channel characteristics.

Existing technologies related to the near-field have the following limitations.

Polar-domain approaches require large dictionaries to maintain high resolution and a high computational load, which makes these approaches too complex to be applied to large-scale systems. That is, in the near-field environment, because the characteristics of the channel are affected by spherical waves, precise measurement of both angle θ and distance r is required. To achieve this, high resolution capable of distinguishing even minute angles and distance intervals is required.

High resolution here refers to the ability of the antenna system to distinguish angular and distance changes in the channel more precisely and accurately, which is essential for near-field channel modeling. However, achieving this high resolution significantly increases system complexity, which is problematic. For reference, the dictionary refers to a set of predefined functions used to express channel characteristics.

Approaches utilizing sub-array configurations are designed to make the near-field environment similar to the far-field, but accuracy issues arise due to limitations in spatial resolution (i.e., in systems with multiple antennas, the inability to precisely distinguish specific signals or angular differences, making it difficult to determine precise direction or distance) and the difficulty in maintaining consistent phase matching (i.e., the difficulty in aligning all antennas to transmit and receive signals with the same phase).

Therefore, there is a need for a technology that can address the channel modeling complexity and location positioning accuracy issues caused by the spherical wave characteristics of the near-field environment, which should be considered in the XL-MIMO system, a key technology for the 6G wireless communication system.

### SUMMARY OF THE INVENTION

The present invention is directed to providing an apparatus and method for near-field channel phase linearization in an extremely large-scale multiple-input multiple-output (XL-MIMO) system to improve user location positioning accuracy in a near-field line-of-sight (LoS) channel environment of a 6G wireless communication system.

According to an aspect of the present invention, there is provided an apparatus for near-field channel phase linearization in an XL-MIMO system, which includes an antenna array module, which includes a plurality of isotropic antennas, receives a user's signal in a near-field environment, and independently collects amplitude and phase data of a signal for each antenna by an array composed of the plurality of isotropic antennas.

In the present invention, the antenna array module may include N antennas arranged in a uniform linear array (ULA) or a non-uniform array.

In the present invention, the apparatus for near-field channel phase linearization in the XL-MIMO system may further include a signal processing and analysis processor, and the signal processing and analysis processor calculates a distance and phase between each antenna and the user, applies a second-order Taylor approximation to approximate a distance relationship between the user and the antenna as a quadratic function, generates a linearized channel response reflecting changes in distance and phase, and calculates a channel response using a fractional channel technique.

In the present invention, the fractional channel technique may include at least one of a fractional channel #1 technique that defines a channel response by calculating a distance and phase relationship between array elements having a relative spacing from a reference antenna and a fractional channel #2 technique that defines a channel response by calculating a distance ratio between array elements symmetrically positioned around a center of the array.

In the present invention, the signal processing and analysis processor may analyze an array response in an angular domain, detect a peak which is a maximum signal intensity, calculate the user's angle and distance information based on the peak, and estimates the user's location based on the information.

In the present invention, the apparatus for near-field channel phase linearization in the XL-MIMO system may further include a data storage and output module, and the data storage and output module stores a signal processing result and linearized channel model data, and outputs a final result through a display or network interface.

In the present invention, the apparatus for near-field channel phase linearization in the XL-MIMO system may be implemented so that the antenna array module, a signal processing and analysis processor, and a data storage and output module are integrated into a single processor.

In the present invention, the signal processing and analysis processor may be implemented to perform beamforming using linearized channel response data to reduce interference and focus signals in a specific direction.

In the present invention, the apparatus for near-field channel phase linearization in the XL-MIMO system may be implemented to accurately estimate the user's location in a near-field environment by adjusting the nonlinearity of a channel response that occurs according to changes in signal transmission/reception distance and angle.

In the present invention, the apparatus for near-field channel phase linearization in the XL-MIMO system may be implemented to overcome the limitations of far-field-based modeling by simultaneously estimating both angle and distance information through a fractionalization-based linearization technique that reflects near-field spherical wave characteristics in a 6G wireless communication system.

According to another aspect of the present invention, there is provided a method of near-field channel phase linearization in an XL-MIMO system, which includes collecting, by a signal processing and analysis processor of an apparatus for near-field channel phase linearization in an XL-MIMO system, a signal received from a user through an array composed of a plurality of isotropic antennas, calculating, by the signal processing and analysis processor, a distance and phase relationship between each antenna and the user using a second-order Taylor approximation, generating, by the signal processing and analysis processor, a fractional channel based on a distance and phase relationship between array elements having a relative spacing from a reference antenna, additionally generating, by the signal processing and analysis processor, a fractional channel based on a distance and phase relationship between array elements symmetrically positioned around a center of the array, and deriving, by the signal processing and analysis processor, a linear channel model that includes angle and distance information by linearizing the generated fractional channel.

In the present invention, in the collecting of the signal received from the user, the plurality of isotropic antennas may be arranged in a ULA, and a spacing between the antennas has a corresponding value according to a wavelength of the signal.

In the present invention, the calculating of the distance and phase relationship between each antenna and the user using the second-order Taylor approximation may include approximating, by the signal processing and analysis processor, a nonlinear distance relationship with each antenna based on the user's location as a quadratic function and adjusting, by the signal processing and analysis processor, a phase change by considering an angular change between antenna array elements.

In the present invention, in the generating of the fractional channel, the signal processing and analysis processor may calculate a signal response ratio between a reference antenna and a specific array element and generate a linearized channel response based on the signal response ratio.

In the present invention, in the additionally generating of the fractional channel, the signal processing and analysis processor may calculate a distance ratio between array elements symmetrically positioned around the center of the array and generate a fractional channel reflecting symmetrical phase characteristics of the signal based on the distance ratio.

In the present invention, in the deriving of the linear channel model, the signal processing and analysis processor may analyze a linearized channel response in an angular domain and detect a maximum signal intensity based on a change in signal intensity to estimate the user's angular information.

In the present invention, in the deriving of the linear channel model, the signal processing and analysis processor may calculate the user's location using linearized channel response data to simultaneously estimate angle and distance information of the signal.

In the present invention, in the deriving of the linear channel model, the signal processing and analysis processor may perform beamforming based on linearized channel response data to reduce interference between signals and focus signals in a specific direction.

In the present invention, after the deriving of the linear channel model, the signal processing and analysis processor may transform signals received from the plurality of antennas into an angular domain through a discrete Fourier transform, detect a peak, which is a maximum value of a signal intensity value, from signal response data transformed into the angular domain, and calculate the user's angle of arrival (AoA) based on the detected peak.

In the present invention, in the deriving of the linear channel model, the signal processing and analysis processor may adjust phase and amplitude data of the signal according to changes in relative distance and angle between the array elements to reflect spherical wave characteristics in a near-field environment.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an exemplary diagram showing a schematic configuration of an apparatus for near-field channel phase linearization in an extremely large-scale multiple-input multiple-output (XL-MIMO) system according to an embodiment of the present invention;

FIG. 2 is a flowchart illustrating a method of near-field channel phase linearization in an XL-MIMO system according to an embodiment of the present invention;

FIG. 3 is an exemplary diagram visually illustrating the index selection and element fractionalization processes in fractional channel #1 and #2 techniques according to an embodiment of the present invention;

FIG. 4A to 4C are graphs showing the results obtained using an original channel and fractional channel #1 and fractional channel #2 techniques in FIG. 1, compared in terms of the relationship between normalized gain and array index; and

FIG. 5 is a graph showing the performance results obtained by analyzing an angle estimation error and distance estimation error according to a change in the size of fractional channel #1 in FIG. 1 under specified signal-to-noise ratio (SNR) conditions (5 dB and 20 dB).

### DETAILED DESCRIPTION OF EXEMPLARY EMBODIMENTS

Hereinafter, embodiments of a standard model-based digital twin generation and management apparatus and control method thereof according to an embodiment of the present invention will be described.

In this process, the thicknesses of the lines and the sizes of the components shown in the accompanying drawings may be exaggerated for the sake of clarity and convenience of description. In addition, the terms described below are terms defined in consideration of their functions in the present invention and may vary depending on the intention or custom of the user or operator. Therefore, the definitions of these terms should be made based on the contents throughout this specification.

Hereinafter, with reference to the accompanying drawings, embodiments of the present invention will be described in detail so that those skilled in the art may easily practice the embodiments. However, the present invention may be implemented in many different forms and is not limited to the embodiments described herein. In addition, in the drawings, parts that are not related to the description of the present invention are omitted in order to clearly describe the present invention, and similar parts are given similar reference numerals.

Throughout the specification, when a part “includes” a component, this does not mean that other components are excluded, but rather other components may be further included unless specifically stated to the contrary.

The implementations described in this specification may be implemented as, for example, methods or processes, devices, software programs, data streams, or signals. Even if discussed only in the context of a single form of implementation (e.g., only as a method), the implementation of the discussed feature may also be implemented in other forms (e.g., as a device or a program). The device may be implemented using suitable hardware, software, firmware, etc. The method may be implemented in a device such as a processor, which generally refers to a processing device including, for example, a computer, a microprocessor, an integrated circuit, or a programmable logic device.

The present invention considers electromagnetic waves having spherical wave characteristics in the near-field in the extremely large-scale multiple-input multiple-output (XL-MIMO) system, which is a key technology for the 6G communication system. This is because, unlike conventional channel modeling methods that assume plane waves in the far-field, situations arise where not only the angles but also the distances between antenna array elements should be precisely considered.

The present invention performs channel modeling based on a second-order Taylor approximation (i.e., a mathematical method of approximating a complex function with a simpler quadratic function) to mitigate near-field phase issues. This method utilizes the fact that a linear function is obtained by differentiating a quadratic function in the continuous domain, and that a fractional relationship exists between observation channel elements when implementing the quadratic function in the discrete domain.

Through this, the present invention provides a model that can be interpreted more intuitively and efficiently than the existing method by linearizing a phase of a channel based on the fractional relationship between channel elements, and based on this phase linearization, performance improvements such as interference mitigation and beam focusing can be implemented.

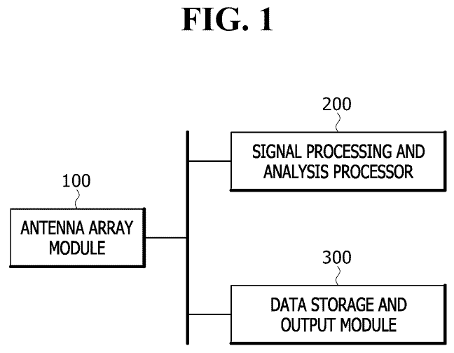

FIG. 1 is an exemplary diagram showing a schematic configuration of an apparatus for near-field channel phase linearization in an XL-MIMO system according to an embodiment of the present invention

Referring to FIG. 1, an apparatus for near-field channel phase linearization in an XL-MIMO system according to the present embodiment may include an antenna array module 100, a signal processing and analysis processor 200, and a data storage and output module 300.

The antenna array module 100, signal processing and analysis processor 200, and data storage and output module 300 may be implemented as software running on an integrated processor.

The antenna array module 100 may be composed of a plurality of antenna arrays for signal transmission and reception, may include N isotropic antennas, and may be arranged in a uniform linear array (ULA) or another form.

The signal processing and analysis processor 200 performs all computation and control functions of the apparatus according to the present embodiment and may be implemented by including one or more processors.

The signal processing and analysis processor 200 may calculate changes in the distance and phase of a signal based on a “Taylor approximation” and a “fractionalization technique.”

The signal processing and analysis processor 200 may linearize nonlinear channels by applying “fractional channel #1” and “fractional channel #2” techniques.

The signal processing and analysis processor 200 may analyze a signal in an angular domain, detect meaningful peaks, and estimate angle and distance information with a user.

The signal processing and analysis processor 200 may manage data flow and control the operation of each function.

The data storage and output module 300 may store and output computed result data. For example, a data storage unit (not shown) may store signal processing results and channel model data, and a data output unit (not shown) may transmit final results to another system or provide the final results visually to a user (e.g., through a display or network interface, etc.).

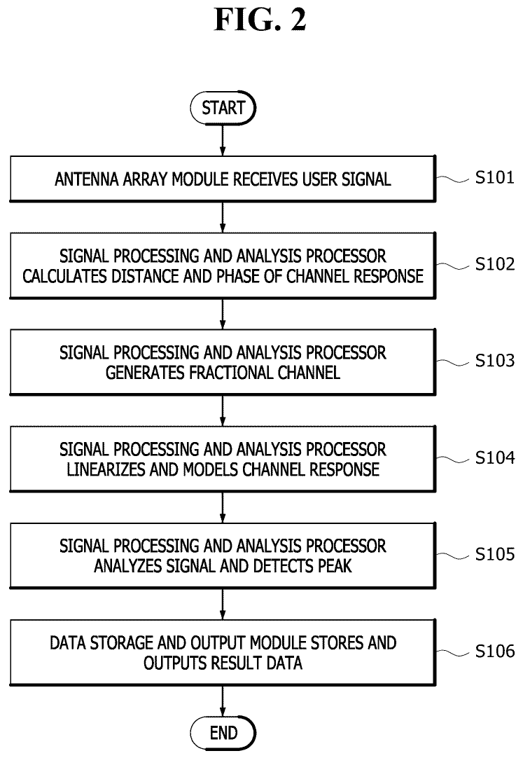

FIG. 2 is a flowchart illustrating a method of near-field channel phase linearization in an XL-MIMO system according to an embodiment of the present invention.

Referring to FIG. 2, the antenna array module 100 receives a user signal (S101).

For example, the antenna array module 100 (e.g., N isotropic antennas) may receive a signal transmitted from the user and collect channel response data for each antenna.

The signal processing and analysis processor 200 calculates a distance and phase of the channel response (S102).

For example, the signal processing and analysis processor 200 may calculate the distance and phase between the antenna and the user from the received channel response data and may approximate a nonlinear signal by applying a second-order Taylor approximation.

The signal processing and analysis processor 200 generates a fractional channel (S103).

For example, fractional channel #1 may calculate a fractional relationship between channel responses using a reference antenna n and a relative spacing m, and fractional channel #2 may calculate a channel response relationship between antennas symmetrically spaced around the center of the array.

The signal processing and analysis processor 200 linearizes and models the channel response (S104).

For example, the signal processing and analysis processor 200 may linearize a nonlinear channel response based on a “fractional channel” and calculate phase and amplitude information of for each angle through the linearized channel model.

The signal processing and analysis processor 200 analyzes the signal and detects a peak (i.e., the maximum signal strength indicating angle and distance information between a user and a base station (BS)) (S105).

For example, the signal processing and analysis processor 200 may analyze a signal in the angular domain and detect a meaningful peak and estimate both angle and distance information between the user and the base station based on this peak.

The data storage and output module 300 stores and outputs the result data (S106).

For example, the data storage and output module 300 may store the final calculated channel model, angle information, and distance information, and when necessary, output the result data to a display or transmit the result data to another system.

Below, operations of the signal processing and analysis processor 200 will be described in more detail.

In this embodiment, an uplink situation in which a single user communicates with a base station having an extremely large aperture array (ELAA) is considered.

Here, the ELAA refers to a large-scale antenna system used in next-generation wireless communication systems such as 6G, which is a form of the XL-MIMO technology, and refers to a system with a very large physical size and an array of hundreds to thousands of antennas.

In this case, it is assumed that the user uses a single isotropic antenna, and the BS is deployed as a ULA composed of N isotropic antennas. That is, in the following embodiments, it is assumed that the user uses an antenna that transmits a single signal identically in all directions (i.e., a single isotropic antenna), while the base station is configured with a structure in which N identical antennas are arranged in a straight line at regular intervals (i.e., a ULA).

The variables for describing the present embodiment are defined as follows.
N: the number of antennas
dn: distance between an n-th antenna in a ULA and a user.
d: distance between a BS and user
βn: channel gain (signal strength or attenuation)
λ: wavelength of a signal (length of radio wave)
Δ: antenna spacing
θ: angle between the BS and user.
b(⋅): an array response vector (characteristic of how antenna array responds to a signal)

Basically, in a free space propagation scenario, the channel response between an n-th antenna of a ULA and a user may be expressed as Expressions 1 and 2 below.

$${h}_{n} = \sqrt{{β}_{n}} {e}^{- j \frac{2 π}{λ} {d}_{n}} \qquad [ Expression 1 ]$$

$${d}_{n} = d \sqrt{1 + \frac{{( n Δ )}^{2}}{{d}^{2}} - \frac{2 n Δ}{d} cos θ} \qquad [ Expression 2 ]$$

In addition, since a channel gain is roughly constant across all antennas, the channel gain may be assumed to be

$$\text{?} = β = \frac{{λ}^{2}}{{( 4 π d )}^{2}}$$

$$\text{?} \text{indicates text missing or illegible when filed}$$

for all n.

Therefore, the N-sized channel response h may be expressed as Expression 3 below.

Here, N-sized means N antennas at the BS, and the channel response h means a value including the strength (gain) and phase change of the signal received by each antenna from the user.

$$h = {[ {h}_{1} , {h}_{2} , … , {h}_{N} ]}^{T} = {h}_{c} b ( θ , d ) , \qquad [ Expression 3 ]$$

Here, h₁, h₂, . . . , h_{N}: are the channel response values received by each of the N antennas.

$$b ( θ , d ) = {[ \text{?} , \text{?} , … , \text{?} ]}^{T} , {h}_{c} \hat{=} \sqrt{β} \text{?}$$

$$\text{?} \text{indicates text missing or illegible when filed}$$

The present embodiment is based on the second-order Taylor approximation (i.e., a mathematical method of approximating a complex function with a simpler quadratic function) as shown in Expression 4 below.

$$\sqrt{1 + x} \approx 1 + \frac{1}{2} x - \frac{1}{8} {x}^{2} \qquad [ Expression 4 ]$$

Expression 2 can be approximated using Expression 4 as shown in Expression 5 below.

$${d}_{n} \approx d - n Δ cos θ + ( \frac{{n}^{2} {Δ}^{2} {sin}^{2} θ}{2 d} ) \qquad [ Expression 5 ]$$

As described above, the present embodiment can perform two types of “fractionalization-based near-field (LoS) channel modeling” as illustrated in FIG. 1. The “fractionalization-based near-field LoS channel modeling” is a channel modeling technique that utilizes fractionalization to linearize the nonlinear characteristics of the channel, which enables more accurate and efficient analysis of complex signal propagation in a near-field environment.

For reference, “fractionalization” means expressing the phase relationship between channel elements in fractional form, which simplifies complex distance and phase changes, linearizes nonlinear channel characteristics, and enables the linearization of nonlinear channel characteristics.

In addition, the “LOS” refers to a situation where a signal propagates along a straight path and reaches a receiver without any obstacles.

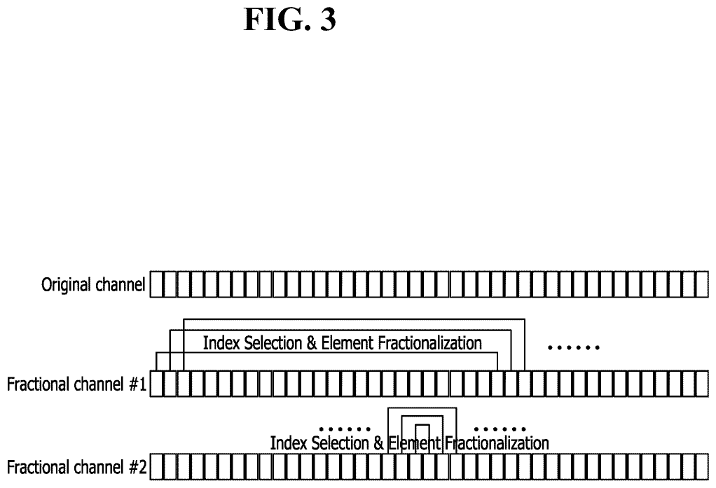

The “fractional channel #1” and “fractional channel #2” techniques in FIG. 3 will be described below. In the “fractional channel #1” technique, when n and m are shifting and spacing indices, respectively, the channel response for shifting index n and spacing index m and the distance between the corresponding indices and the user are as shown in Expressions 6 and 7 below, respectively.

That is, Expression 6 defines the channel response, and Expression 7 defines the distance between users.

In this case, the “fractional channel #1” and “fractional channel #2” techniques are two approaches for linearizing and more efficiently modeling the nonlinear phase changes occurring in near-field channel environments, and each technique may calculate and express the phase change in a channel using fractionalization.

Here, the shifting index n represents the position of a particular antenna element within the array, for example, n represents the n-th antenna in the antenna array, and serves as a reference for the user to refer to other antennas within the array. In addition, the spacing index m represents the spacing (difference) between two antennas in the array, for example, m represents the relative distance (based on the number of antennas) between the antenna to be compared and the reference antenna n.

$${h}_{n + m} = \sqrt{β} {e}^{- j \frac{2 π}{λ} {d}_{n + m}} \qquad [ Expression 6 ]$$

$${d}_{n + m} \approx d - ( n + m ) Δ cos θ + ( \frac{{( n + m )}^{2} {Δ}^{2} {sin}^{2} θ}{2 d} ) \qquad [ Expression 7 ]$$

Therefore, when “fractional channel #1” is expressed as q(h; m)=[q₁, . . . , q_{N-m}]^{T}, it can be defined as in Expression 8 below for all shifting indices n.

$${q}_{n} \hat{=} \frac{{h}_{n + m}}{{h}_{n}} = {e}^{- j \frac{2 π}{λ} ( {d}_{n + m} - {d}_{n} )} \qquad [ Expression 8 ]$$

In Expression 8, the phase (dₙ₊ₘ−dₙ) is approximated and organized as Expression 9 below.

$$[ Expression 9 ]$$

$${d}_{n + m} - {d}_{n} \approx - m Δ cos θ + ( 2 nm + {m}^{2} ) {Δ}^{2} ( \frac{{sin}^{2} θ}{2 d} ) = ( \frac{m {Δ}^{2} {sin}^{2} θ}{d} ) n + \frac{m}{2} ( \frac{m {Δ}^{2} {sin}^{2} θ}{d} - 2 Δ cos θ )$$

Therefore, q(h; m) can be modeled as a linear phase for the shifting index n.

Therefore, when “fractional channel #2” is expressed as p(h)=[p₁, . . . , p_{N/2}]^{T}, it can be defined as in Expression 10 below for all indices k.

$${p}_{k} \hat{=} \frac{{d}_{N / 2 + k}}{{d}_{N / 2 - k + 1}} = {e}^{- j \frac{2 π}{λ} ( {d}_{N / 2 + k} - {d}_{N / 2 - k + 1} )} \qquad [ Expression 10 ]$$

Next, the phase of Equation 10 (d_{N/2+k}−d_{N/2-k+1}) can be approximated as Expression 11 below.

$${d}_{N / 2 + k} - {d}_{\frac{N}{2} - k + 1} \approx ( ( N + 1 ) ( \frac{{Δ}^{2} {sin}^{2} θ}{d} ) - 2 Δ cos θ ) k \qquad [ Expression 11 ]$$

Therefore, p(h) can also be modeled as a linear phase for all indices k.

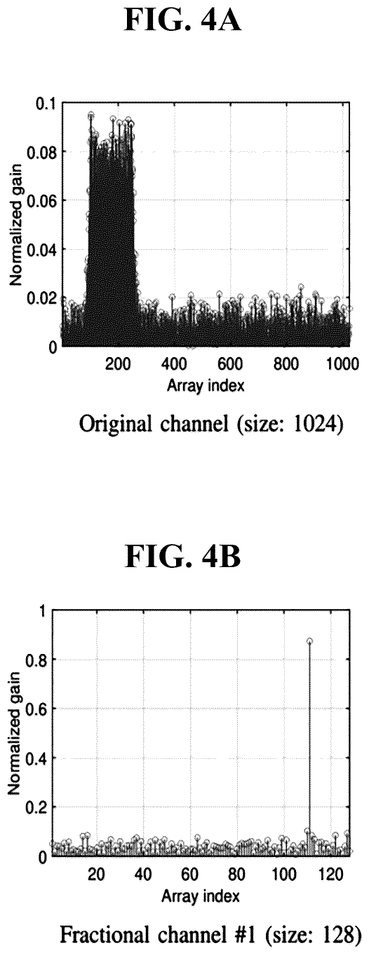

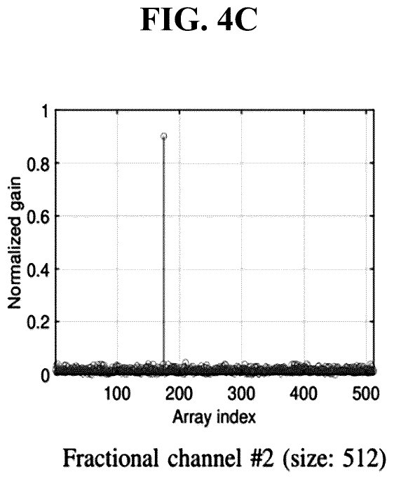

The experimental results obtained using the phase linearization technique for the channel response described above are as shown in FIGS. 4A to 4C.

FIG. 4A shows an array response for the original channel obtained through a discrete Fourier transform for the near-field channel in the angular domain.

Here, the angular domain is the domain for analyzing signals based on angle, allowing one to determine, for example, the direction from which a specific signal originates or the direction toward which the specific signal travels. An array response refers to a graph or value indicating how well an antenna array responds to signals arriving from various angles.

In this case, it is difficult to estimate important channel information such as angle and distance because meaningful peaks (i.e., peaks representing the maximum signal strength indicating the angle and distance information between the user and the BS) cannot be identified due to the nonlinear phase in the near-field.

On the other hand, FIGS. 4B and 4C show the results obtained using the above-described “fractional channel #1” and “fractional channel #2” techniques, respectively, and it can be confirmed that meaningful peak detection is possible compared to the original channel. Here, the “original channel” refers to the existing channel model used before applying the “fractional channel #1” and “fractional channel #2” techniques, which means a channel modeled simply according to the existing method without considering nonlinear characteristics when processing signals in a near-field environment.

The experimental environment for FIGS. 4A to 4C is as follows.
d: 15 meters
θ: π/3 radian
signal-to-noise ratio (SNR): 10 dB
λ: 0.0125 meters
N: 1024

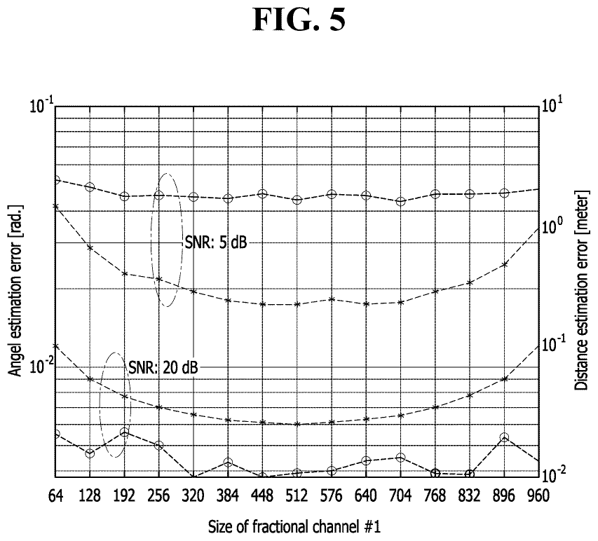

FIG. 5 shows the performance of fractional channel #1 technique according to the size of fractional channel #1 to demonstrate the superiority of the angle and distance estimation performance of the technique according to the present embodiment.

In the experiment, cases when the SNR is 5 dB and 20 dB were considered, and orange represents a distance estimation error and blue represents an angle estimation error. When the SNR is 5 dB, the distance estimation error is approximately 1 meter or less and the angle estimation error is 0.1 radian or less, when the SNR is 20 dB, the distance estimation error is approximately 0.1 meter or less and the angle estimation error is 0.01 radian or less, and accordingly, excellent estimation performance can be confirmed.

The experimental environment for FIG. 5 is as follows.
N: 1024
channel gain: CN(0,1)
θ(−1, 1) [rad.]
d: (10, 40) [meter]
λ: 0.0125 [meter]
Δ: 0.00625 [meter]

Based on the fractionalization of the near-field LOS channel in the XL-MIMO system, it is possible to linearly model the nonlinear channel phase in near-field situations that possess complex phase information.

In addition, the fractionalization of the near-field LOS channel in the XL-MIMO system is efficient because it can reduce the computational complexity compared to existing techniques for linearization, and it can achieve accurate parameter estimation by obtaining an accurate channel representation, thereby improving the accuracy of user location estimation in near-field situations.

According to the present invention, user positioning accuracy can be improved in the near-field LoS channel environment of a 6G wireless communication system. Although the present invention has been described with reference to embodiments illustrated in the drawings, these are merely exemplary, and those skilled in the art will understand that various modifications and equivalent other embodiments are possible therefrom. Therefore, the technical protection scope of the present invention should be defined by the following patent claims. In addition, the implementations described in this specification may be implemented as, for example, methods or processes, devices, software programs, data streams, or signals. Even if discussed only in the context of a single form of implementation (e.g., only as a method), the implementation of the discussed feature may also be implemented in other forms (e.g., as a device or a program). The device may be implemented using suitable hardware, software, firmware, etc. The method may be implemented in a device such as a processor, which generally refers to a processing device including, for example, a computer, a microprocessor, an integrated circuit, or a programmable logic device.

What is claimed is:

1. An apparatus for near-field channel phase linearization in an extremely large-scale multiple-input multiple-output (XL-MIMO) system, the apparatus comprising an antenna array module,
wherein the antenna array module includes a plurality of isotropic antennas, receives a user's signal in a near-field environment, and independently collects amplitude and phase data of a signal for each antenna by an array composed of the plurality of isotropic antennas.

2. The apparatus of claim 1, wherein the antenna array module includes N antennas arranged in a uniform linear array (ULA) or a non-uniform array.

3. The apparatus of claim 1, further comprising a signal processing and analysis processor,
wherein the signal processing and analysis processor calculates a distance and phase between each antenna and the user, applies a second-order Taylor approximation to approximate a distance relationship between the user and the antenna as a quadratic function, generates a linearized channel response reflecting changes in distance and phase, and calculates a channel response using a fractional channel technique.

4. The apparatus of claim 3, wherein the fractional channel technique includes at least one of:
a fractional channel #1 technique that defines a channel response by calculating a distance and phase relationship between array elements having a relative spacing from a reference antenna; and
a fractional channel #2 technique that defines a channel response by calculating a distance ratio between array elements symmetrically positioned around a center of the array.

5. The apparatus of claim 3, wherein the signal processing and analysis processor analyzes an array response in an angular domain, detects a peak which is a maximum signal intensity, calculates the user's angle and distance information based on the peak, and estimates the user's location based on the information.

6. The apparatus of claim 1, further comprising a data storage and output module,
wherein the data storage and output module stores a signal processing result and linearized channel model data and outputs a final result through a display or network interface.

7. The apparatus of claim 1, which is implemented so that the antenna array module, a signal processing and analysis processor, and a data storage and output module are integrated into a single processor.

8. The apparatus of claim 3, wherein the signal processing and analysis processor is implemented to perform beamforming using linearized channel response data to reduce interference and focus signals in a specific direction.

9. The apparatus of claim 1, which is implemented to accurately estimate the user's location in a near-field environment by adjusting nonlinearity of a channel response that occurs according to changes in signal transmission/reception distance and angle.

10. The apparatus of claim 1, which is implemented to overcome limitations of far-field-based modeling by simultaneously estimating both angle and distance information through a fractionalization-based linearization technique that reflects near-field spherical wave characteristics in a sixth-generation (6G) wireless communication system.

11. A method of near-field channel phase linearization in an extremely large-scale multiple-input multiple-output (XL-MIMO) system, the method comprising:
collecting, by a signal processing and analysis processor of an apparatus for near-field channel phase linearization in an XL-MIMO system, a signal received from a user through an array composed of a plurality of isotropic antennas;
calculating, by the signal processing and analysis processor, a distance and phase relationship between each antenna and the user using a second-order Taylor approximation;
generating, by the signal processing and analysis processor, a fractional channel based on a distance and phase relationship between array elements having a relative spacing from a reference antenna;
additionally generating, by the signal processing and analysis processor, a fractional channel based on a distance and phase relationship between array elements symmetrically positioned around a center of the array; and
deriving, by the signal processing and analysis processor, a linear channel model that includes angle and distance information by linearizing the generated fractional channel.

12. The method of claim 11, wherein, in the collecting of the signal received from the user, the plurality of isotropic antennas are arranged in a uniform linear array (ULA), and a spacing between the antennas has a corresponding value according to a wavelength of the signal.

13. The method of claim 11, wherein the calculating of the distance and phase relationship between each antenna and the user using the second-order Taylor approximation includes:
approximating, by the signal processing and analysis processor, a nonlinear distance relationship with each antenna based on the user's location as a quadratic function; and
adjusting, by the signal processing and analysis processor, a phase change by considering an angular change between antenna array elements.

14. The method of claim 11, wherein, in the generating of the fractional channel, the signal processing and analysis processor calculates a signal response ratio between a reference antenna and a specific array element and generates a linearized channel response based on the signal response ratio.

15. The method of claim 11, wherein, in the additionally generating of the fractional channel, the signal processing and analysis processor calculates a distance ratio between array elements symmetrically positioned around the center of the array and generates a fractional channel reflecting symmetrical phase characteristics of the signal based on the distance ratio.

16. The method of claim 11, wherein, in the deriving of the linear channel model, the signal processing and analysis processor analyzes a linearized channel response in an angular domain and detects a maximum signal intensity based on a change in signal intensity to estimate the user's angular information.

17. The method of claim 11, wherein, in the deriving of the linear channel model, the signal processing and analysis processor calculates the user's location using linearized channel response data to simultaneously estimate angle and distance information of the signal.

18. The method of claim 11, wherein, in the deriving of the linear channel model, the signal processing and analysis processor performs beamforming based on linearized channel response data to reduce interference between signals and focus signals in a specific direction.

19. The method of claim 11, wherein, after the deriving of the linear channel model, the signal processing and analysis processor transforms signals received from the plurality of antennas into an angular domain through a discrete Fourier transform, detects a peak, which is a maximum value of a signal intensity value, from signal response data transformed into the angular domain, and calculates the user's angle of arrival (AoA) based on the detected peak.

20. The method of claim 11, wherein, in the deriving of the linear channel model, the signal processing and analysis processor adjusts phase and amplitude data of the signal according to changes in relative distance and angle between the array elements to reflect spherical wave characteristics in a near-field environment.
